(19) United States
(12) Patent Application Publication
(10) Pub. No.: US 2013/0253950 A1
(43) Pub. Date: Sep. 26, 2013

(54) METHOD AND APPARATUS FOR COLLECTING PATIENT IDENTIFICATION

(71) Applicant: HILL-ROM SERVICES, INC., Batesville, IN (US)

(72) Inventors: Irvin J. VANDERPOHL, III, Greensburg, IN (US); Varad N. Srivastava, Batesville, IN (US); Steven A. Dixon, Cincinnati, OH (US)

(73) Assignee: Hill-Rom Services, Inc., Batesville, IN (US)

(21) Appl. No.: 13/793,414

(22) Filed: Mar. 11, 2013

Related U.S. Application Data
(60) Provisional application No. 61/752,100, filed on Jan. 14, 2013.
(60) Provisional application No. 61/613,961, filed on Mar. 21, 2012.

(51) Int. Cl. G06F 19/00

(52) U.S. Cl. CPC G06F 19/363
USPC 705/3

(57) ABSTRACT

A patient support apparatus includes a microphone and a controller. The microphone is configured to record a patient's verbal acknowledgement of his identity and generate a first input signal in response to the patient's verbal acknowledgement.

### CROSS-REFERENCE TO RELATED APPLICATIONS

The present application claims the benefit, under 35 U.S.C. §119(e), of U.S. Provisional Application No. 61/752,100, which was filed Jan. 14, 2013 and U.S. Provisional Application 61/613,961, which was filed Mar. 21, 2012, the entirety of each of the disclosures of which are hereby incorporated herein by reference.

### BACKGROUND

The present disclosure is related to a patient support apparatus, and in a particular to method of identifying a patient using the patient support apparatus. More particularly, the present disclosure relates to a method of identifying a patient using the patient's verbal authentication of his identity.

A hospital protocol often requires the patient to be properly identified prior to administering medication to the patient. For instance, a hospital protocol may require the patient to provide his/her name and/or date of birth prior to administering medication to the patient. The hospital protocol may also require the patient to affirm his/her identity as evidence of consent to receive the medication or treatment. The patient's affirmance of his/her identity is often stored in a physical medical record maintained for the patient. The inclusion of the patient's affirmance of his/her identity in the medical record provides evidence of adherence to the hospital protocol. Hospital personnel often manually verify the patient's affirmance of his/her identity in the patient's medical record prior to administering treatment to the patient. Automated processes for storing the patient's affirmance of his/her identity in the patient's medical record facilitate compliance with hospital protocol and minimize errors associated with such manual verification.

### SUMMARY

The present application discloses one or more of the features recited in the appended claims and/or the following features which, alone or in any combination, may comprise patentable subject matter:

According to one aspect of the present disclosure, a patient support apparatus comprises a support frame, an input sensor, and a controller coupled to the support frame. The input sensor is configured to provide a first input signal indicative of a verbal acknowledgement provided by a patient of a patient's identity. The controller includes a processor and memory. The controller is configured to receive the input signal and associate the input signal with the patient's identity to establish a first patient entry in a patient's medical record. The controller is also configured to store the first patient entry in the patient's medical record in memory so that evidence of adherence to a hospital protocol is established.

In some embodiments, the input sensor is a microphone. The patient support apparatus may further comprise a siderail coupled to the support frame. The siderail may move relative to the support frame and the microphone may be coupled to the siderail to move therewith.

In some embodiments, the patient support apparatus further comprises a pendant coupled to the support frame. The pendant may move relative to the support frame and the microphone may be coupled to the pendant to move therewith. The controller may be further configured to add a date and a time to the first patient entry in which the first input signal was received.

The patient support apparatus may further comprise a first communication link that may be coupled to the controller. The communication link may be configured to communicate the first patient entry to a hospital information system. The patient support apparatus may further include a selection input that may be coupled to the controller. The selection input may be configured to provide a selection input signal indicative of a medical therapy to be provided to patient resting on the support frame.

The controller may be further configured to determine if the medical therapy is appropriate for the patient. The controller may further be configured to issue a speaking prompt to the patient to cause the patient to speak so that the input sensor provides the first input. The speaking prompt may be a visual prompt, an audible prompt, or both. The controller may be further configured to issue a therapy prompt if the medical therapy is appropriate for the patient. The therapy prompt causes the caregiver to administer the medical therapy to the patient. The controller may be further configured to associate the selection input signal, the patient identity, and the first input signal to establish a second patient entry in the patient's medical record. The second patient entry may be stored in the memory of the controller.

The patient support apparatus may further comprise a communication link. The communication link may be coupled to the controller to communicate the second patient entry to a hospital information system.

The patient support apparatus may further comprise a medication scanner that may be coupled to the controller. The medication scanner may be configured to provide a medication input signal indicative of a medication scanned by the medication scanner to the controller.

The controller may be further configured to issue a scan prompt to a caregiver. The scan prompt may cause the caregiver to scan the medication. The controller may then receive the medication input signal and determine if the medication scanned is appropriate for the patient. The controller may further be configured to issue an administer prompt if the medication is appropriate for the patient that causes the caregiver to administer the medication to the patient. The controller may further be configured to associate the medication input signal with the patient identity and the first input signal to establish a second patient entry of the patient's medical record. The second patient entry may be stored in the memory of the controller.

The patient support apparatus may further comprise a communication link. The communication link may be coupled to the controller to communicate the first and second patient entries to a hospital information system.

The controller may further be configured to associate the medication input signal, the selection input signal, the patient identity, and the first input signal to establish a second patient entry in the patient's medical record. The second patient entry may be stored in the memory of the controller.

According to another aspect of the present disclosure, a method of obtaining a patient entry of a patient's medical record comprises several steps. The steps include receiving an initial identity signal indicative of a patient's initial identity from a first sensor coupled to a patient support apparatus, recording a verbal acknowledgement of the patient's identity provided by the patient using a microphone coupled to the patient support apparatus to provide a recording that confirms the patient's initial identity, storing the recording in memory included in the patient support apparatus to establish a patient entry of a patient's medical record, and transmitting the patient entry to a hospital information system.

The method may further comprise the step of charting an accumulation of patient entries of the patient over time. As a result, evidence of adherence to a protocol for delivering medical care is provided.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a top plan view of a patient's room located in a hospital showing a first embodiment of a patient support apparatus used to identify a patient prior to administering medical treatment to the patient and to store evidence of the patient's identity on an external information system;

FIG. 2 is a view similar to FIG. 1 showing a second embodiment of a patient support apparatus in accordance with the present disclosure;

FIG. 3 is a view similar to FIG. 2 showing a third embodiment of a patient support apparatus in accordance with the present disclosure;

FIG. 4 is an enlarged top plan view of a fourth embodiment of a patient support apparatus showing that the patient support apparatus includes a pendant as suggested in FIGS. 4A-4C;

FIG. 4A is an elevation view of a pendant included in the patient support apparatus of FIG. 4 showing a first pendant view;

FIG. 4B is a view similar to FIG. 4A showing a second pendant view;

FIG. 4C is a view similar to FIG. 4B showing a third pendant view;

FIG. 5 is a diagrammatic view of a first set of instructions executable by a controller included in the patient support apparatus of FIGS. 1 and 4;

FIG. 6 is a diagrammatic view of a second set of instructions executable by a controller included in the patient support apparatus of FIG. 2;

FIG. 7 is a diagrammatic view of a third set of instructions executable by a controller included in the patient support apparatus of FIG. 2;

FIG. 8 is a diagrammatic view of a fourth set of instructions executable by a controller included in the patient support apparatus of FIG. 3.

FIG. 9 is diagrammatic view of the patient support apparatus of FIGS. 1-4 showing that the controller of the patient support apparatus communicates with the external information system through a communication link; and

FIG. 10 is diagrammatic view of the controller of FIG. 9.

### DETAILED DESCRIPTION OF THE DRAWINGS

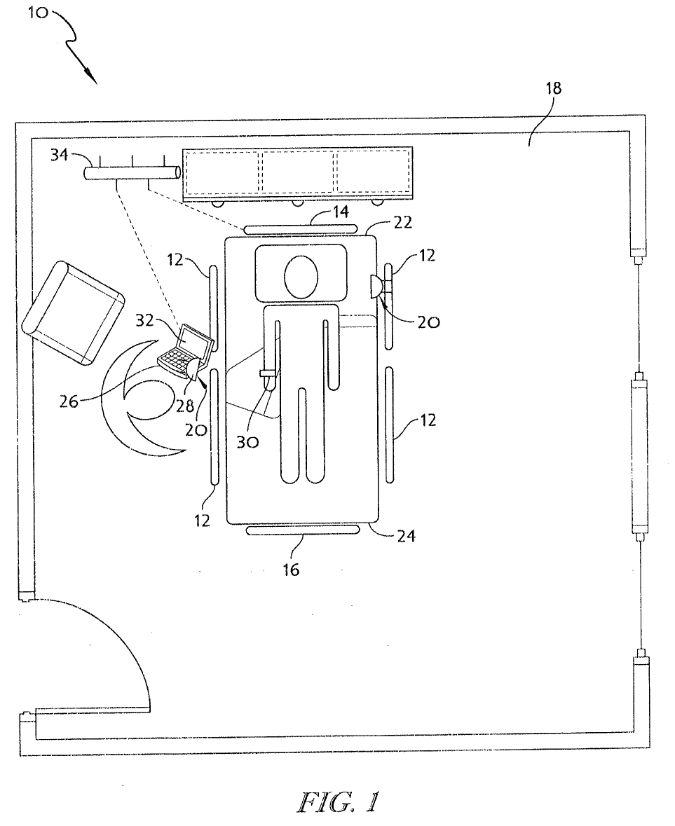

Referring to FIG. 1, a patient support apparatus is illustratively embodied as a hospital bed 10. Typically, the bed 10 includes a frame 9 supported by wheels or casters, a mattress supported by the frame 9, a number of siderails 12, a headboard 14, and a footboard 16. The bed 10 includes a microphone 20, also called an input sensor, used as a means for obtaining a voice recording of a patient supported by the bed 10. The voice recording of the patient may include a verbal authentication of the patient's identity. The verbal authentication of the patient's identity may include a name of the patient and/or a date of birth of the patient. The verbal authentication of the patient's identity may be stored in a medical records database as part of the patient's medical record. In addition, the voice recording of the patient may include the patient's verbal consent to receive medical care. The patient's verbal consent to receive medical care may also be stored in the medical records database as part of the patient's medical record.

As shown in FIG. 1, the bed 10 is located in a patient's room 18 of a hospital. The patient's room 18 may include one or more room devices, such as an overbed light, a night/reading light, a television or entertainment system, or other lighting devices. The room devices may be coupled to the bed 10 or spaced apart from the bed 10 within the patient's room 18.

The microphone 20 is coupled to the frame 9 of the bed 10 in closer proximity to a head end 22 of the bed 10 than a foot end 24 of the bed 10 in a first embodiment of the present disclosure as shown in FIG. 1. The headboard 14 is positioned along the head end 22 of the bed 10 and the footboard 16 is positioned along the foot end 24 of the bed 10. The foot end 24 and the head end 22 define opposite ends of the bed 10.

The microphone 20 is positioned to facilitate the voice recording for the patient resting on the bed 10. The microphone may provide an input signal that serves as an initial identity signal indicative of the patient's initial identity. The voice recording includes the patient's name and/or the date of birth of the patient for the purpose of establishing the patient's identity. In another example, the voice recording may be used to indicate that a patient has given consent to receive medical care. For the purposes of the present disclosure, the microphone 20 may be attached to the frame 9 of the bed 10 at any location between the head end 22 and the foot end 24. In another example, the microphone 20 may be coupled to one of the siderails 12 of the bed 10. In yet another example, the microphone 20 may be attached to the headboard 14 at the head end 22 or the footboard 16 at the foot end 24.

The bed 10 may include a number of electronically controlled functions. For example, the bed 10 may include a patient input-output device capable of receiving and processing electrical input from a number of manually operable switches coupled to the patient input-output device. The patient input-output device may be used to enable a patient to activate and deactivate certain bed functions when the patient is positioned on the bed 10. Such bed functions might include raising or lowering certain sections of the bed 10, placing a call to a hospital communication system, such as a nurse call system, or turning on lighting or other room devices.

The bed 10 may further include a caregiver input-output device capable of receiving and processing electrical input from a number of manually operable switches coupled to the caregiver input-output device. Similar to the patient input-output device, the caregiver input-output device may enable the caregiver to configure, activate and deactivate certain of the electronically controlled bed functions.

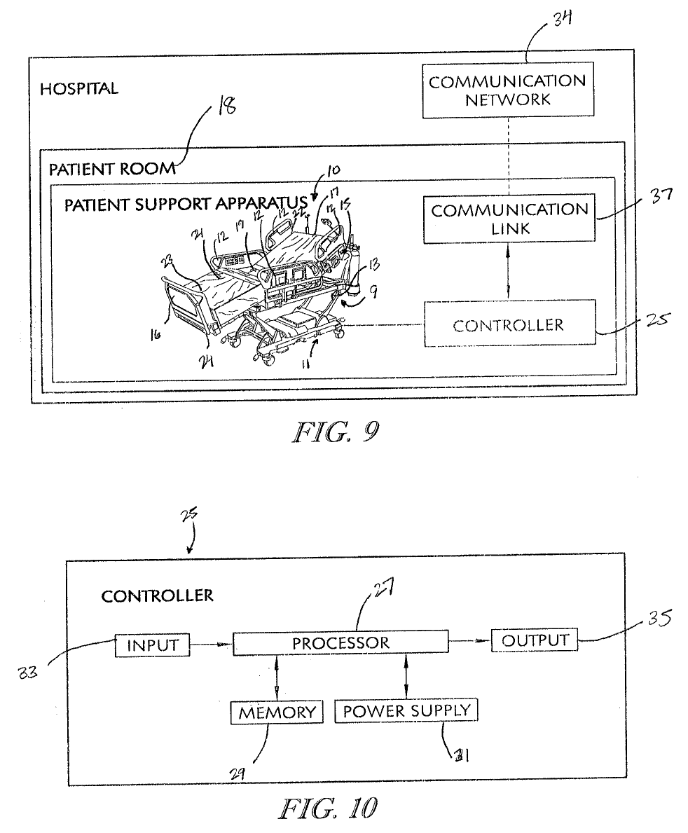

A controller 25 included in the bed 10 manages electronically controlled functions associated with the bed 10 as shown in FIG. 10. The controller 25 includes a processor 27 and memory 29. The processor 27 receives power from a power supply 31. The power supply 31 may be located within the patient's room 18 or in the bed 10. The processor 27 is configured to execute instructions stored in memory 29. The controller 25 is configured to receive input signals from one or more input devices 33, such as an input signal from the input sensor, that are coupled to the controller 25. The controller 25 is also configured to transmit output signals to one or more output devices 35 that are coupled to the controller 25. The controller 25 may be contained within a housing that is mountable to a fixed location on the bed 10. The housing may also contain electrical circuitry included with the controller 25. The controller 25 may be coupled to the frame 9 as suggested in FIG. 9. The controller 25 may also be coupled to the siderails 12, the headboard 14, or the footboard 16.

The controller 25 may receive electrical input from input devices 33 such as the patient input-output device or the caregiver input-output device, via a bed network. The bed network may be an electronic network configured according to a CAN (Controller Area Network) or Echelon protocol, or any other suitable bed network communications protocol.

As shown in FIG. 1, a pendant 26 illustratively embodies a caregiver input-output device included in the bed 10. The pendant 26 is configured to communicate with the controller 25 of the bed 10 and is operable when coupled to the bed 10 or physically separated from the bed 10 within the patient's room 18. The pendant 26 includes an optical detector 28, also called a selection input, capable of detecting indicia with a predetermined pattern. The pendant 26 is configured to communicate a selection input signal indicative of data associated with the indicia to the controller 25. The selection input signal may serve as an initial identity signal that is indicative of the patient's initial identity. As shown in FIG. 1, the optical detector 28 is a Radio Frequency Identification (RFID) tag reader and the indicia is an RFID bracelet 30 worn by the patient resting on the bed 10.

The pendant 26 includes a touchscreen display 32 as shown in FIG. 1. The touchscreen display 32 may include a graphical user interface enabling the caregiver to configure, activate, and deactivate certain of the electronically controlled bed functions or the room devices. The touchscreen display 32 is configured to display visual indications viewable by the caregiver or other persons in the patient's room 18 in response to commands or instructions provided by the controller 25. The touchscreen display 32 is also configured to emit audible indications in response to commands or instructions provided by the controller 25. In some embodiments, the pendant 26 may be configured to emit audible indications in response to commands or instructions provided by the controller 25.

Electrical communications that originate at the bed 10, through either the controller 25 or the pendant 26, may be communicated to a communication network 34 through a communication link 37 as shown in FIG. 9. The communication link 37 may be a wireless device enabling data to be exchanged between the controller 25 and the communication network 34, such as a Bluetooth device. The communication link 37 may also be a wired RS-232 connection permitting data to be exchanged between the controller 25 and the communication network 34. The communication link 37 is included in bed 10 and is coupled to both the controller 25 and the communication network 34 as shown in FIG. 9.

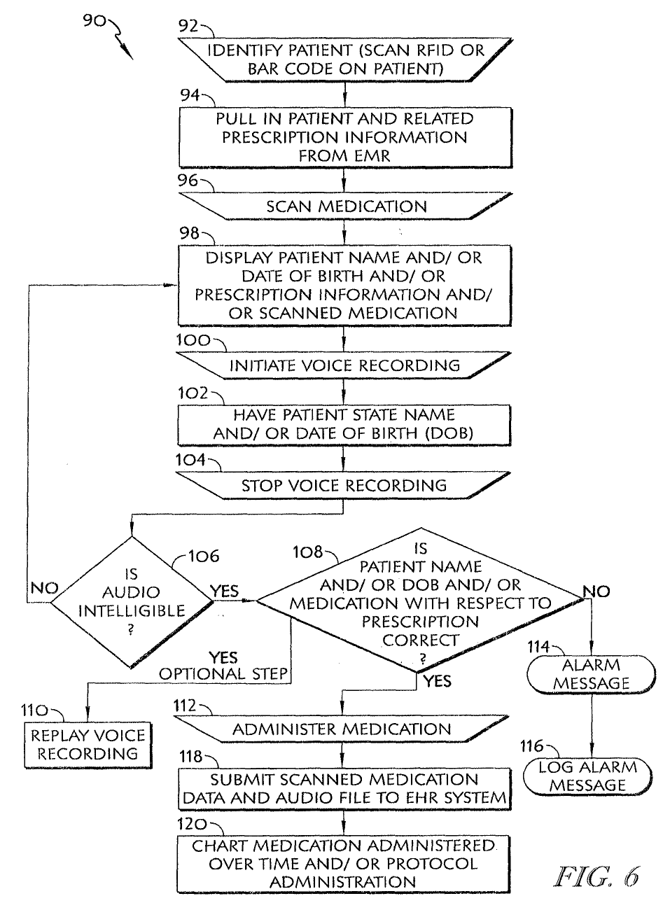

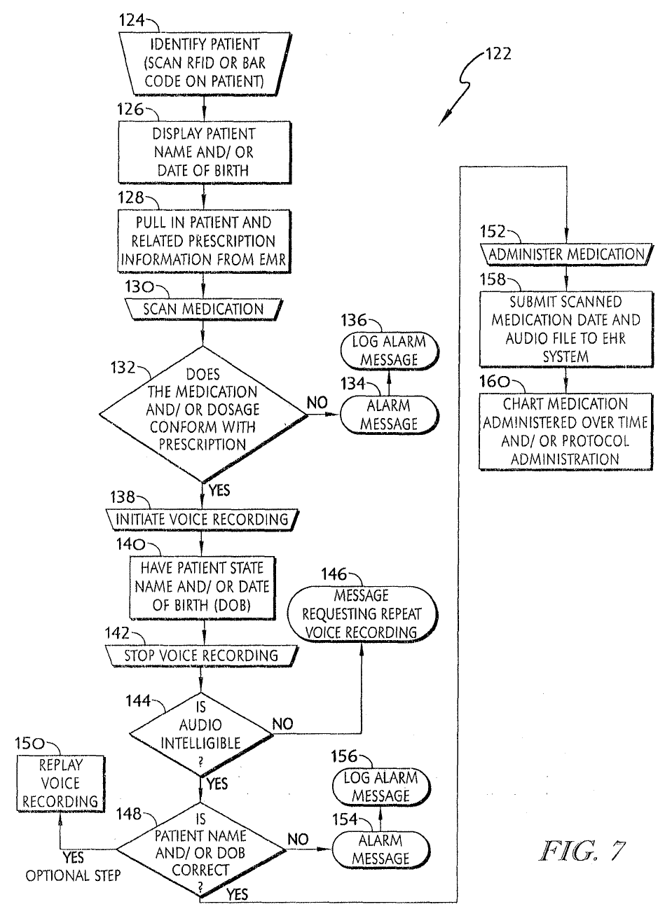

The communication network 34 may serve to link the bed 10 to the nurse call system which may include a master station and a number of user stations. Each of the nurse call system user stations may include computers permitting caregiver access to an external information system such as an electronic database containing patient medical records. As shown in FIGS. 6 and 7, medical records including the patient name, the date of birth of the patient, and prescription information may be communicated from the medical records database through the communication network 34 to the controller 25 and the pendant 26. Such information may be useful prior to initiating the voice recording for the patient resting on the bed 10.

As suggested in FIG. 1, the bed 10 includes means for obtaining a recording of a verbal acknowledgement by the patient of the patient's identity and storing the recorded verbal acknowledgement electronically. The patient's identity may be ascertained initially using the RFID bracelet 30. The RFID tag reader 28 receives a signal from the RFID bracelet 30 and displays the patient information, which may include the patient's name, date of birth, and prescription information, on the touchscreen display 32 of the pendant 26. The patient information may be communicated directly to the communication network 34, as shown in FIG. 1, or to the controller 25. The controller 25, in response to receiving the patient information from the pendant 26, may issue a prompt to the pendant 26 that is viewable by a caregiver or other persons in the vicinity of the bed 10. The prompt may be a visual indication or an audible indication to initiate the voice recording of the patient's name and/or the patient's date of birth. Once the voice recording is completed using the microphone 20, the recording may be stored as a patient entry by the controller 25 in memory 29 included in the controller 25. The controller 25 may add the time and date at which the recording was stored to the patient entry, as well as a patient identifying indicator.

As suggested in FIG. 1, the patient entry of the recorded verbal acknowledgement of the patient's identity may be communicated from the controller 25 to the medical records database via the communication network 34. Thereafter, the patient entry may be incorporated into an electronic history file maintained for the patient. The electronic history file includes the patient's medical records. Incorporation of the patient entry into the patient's electronic history file provides evidence of adherence to a protocol for delivering medical care that requires patient identity to be established prior to administering medical care.

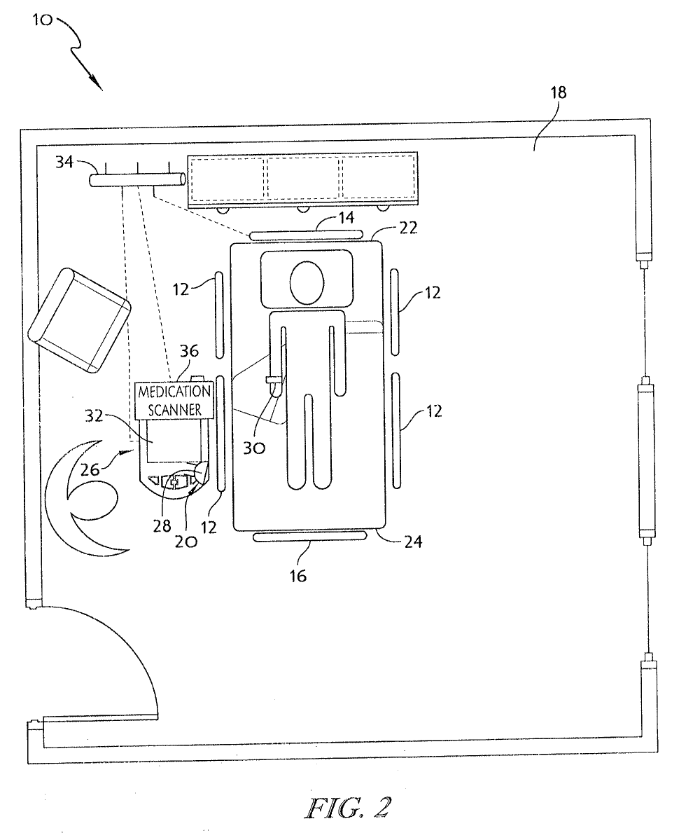

In a second embodiment of the present invention shown in FIG. 2, the microphone 20 is shown spaced-apart from the bed 10 and is coupled to the pendant 26 to move therewith relative to the bed 10. The pendant 26 is spaced apart from the siderails 12 and located between the head end 22 and the foot end 24 of the bed 10 as shown, for example, in FIG. 2. As suggested in FIG. 2, the pendant 26 may be positioned in patient's room 18 relative to the bed 10 to facilitate a voice recording for a patient resting on the bed 10.

A medication scanner 36 is coupled to the pendant 26 in addition to the microphone 20 as shown in FIG. 2. The medication scanner 36 may be used to scan the medication to be administered to the patient resting on the bed 10. The medication scanner 36 is configured to provide a medication input signal that communicates patient information to the pendant 26. Patient information such as the patient's name, date of birth, and dosage may be displayed on the touchscreen display 32 once the medication is scanned using the medication scanner 36. As shown in FIG. 2, the medication scanner 36 is configured to communicate with the medical records database through the communication network 34.

The medication scanner 36 is also configured to communicate with the controller 25 via the pendant 26 as suggested in FIG. 2. The pendant 26 is capable of being used to ascertain a patient's identity with the RFID tag reader 28, record the verbal acknowledgement of the patient's identity with the microphone 20, and scan the medication to be administered to the patient with the medication scanner 36. Data generated using the RFID tag reader 28, the microphone 20, or the medication scanner 36 may be communicated from the pendant 26 to the controller 25 and thereafter to the communication network 34 as suggested in FIG. 2.

Patient information communicated to the communication network 34 may be used to identify the electronic history file maintained for the patient. The patient medical records contained in the electronic history file may be communicated to the pendant 26 and to the controller 25 through the communication network 34. The controller 25, in response to receiving the patient medical records, may issue a scan prompt to the pendant 26 that is viewable by the caregiver or other persons in the vicinity of bed 10. The scan may be a visual indication or an audible indication to use the medication scanner 36 to scan the medication to be administered to the patient. Once the medication is scanned, the controller 25 may issue a speak prompt to the pendant 26 that is viewable by the caregiver or other persons in the vicinity of bed 10. The speak prompt may be a visual indication or an audible indication to initiate the voice recording of the patient's name and/or the patient's date of birth. Once the voice recording is received using the microphone 20, the recording may be stored as a patient entry by the controller 25. The controller 25 may add the time and date at which the recording was stored to the patient entry as well as a patient identifying indicator.

The scanned medication information and the patient entry of the recorded verbal acknowledgement of the patient's identity may be communicated from the controller 25 to the medical records database via the communication network 34. Thereafter, the patient entry and the scanned medication information may be incorporated into the electronic history file maintained for the patient. Incorporation of the patient entry and the scanned medication data into the patient electronic history file provides evidence of adherence to a protocol for delivering medical care that requires patient identity to be established prior to administering medical care.

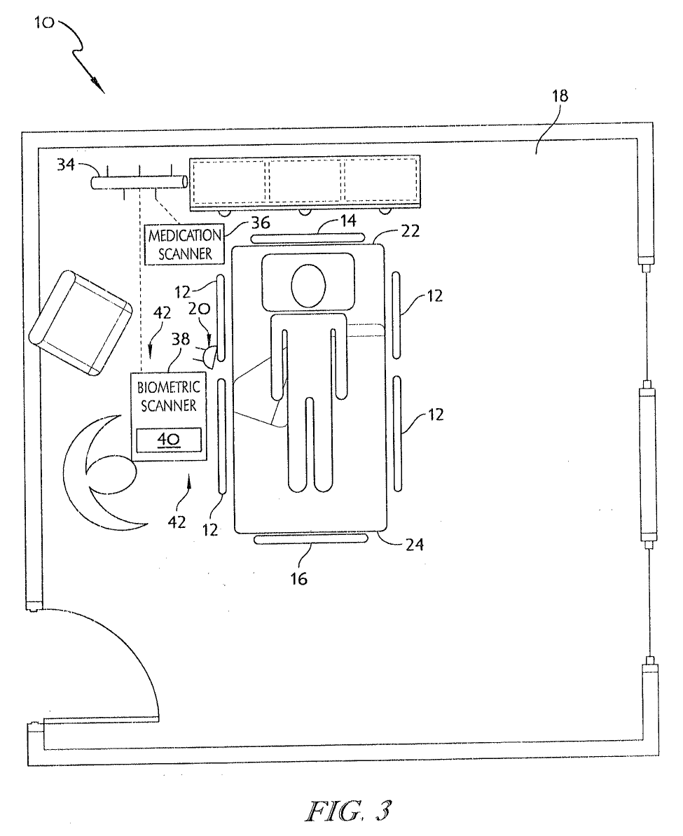

In a third embodiment of the present invention shown in FIG. 3, a biometric scanner 38 serves as a patient-identifying device in place of the microphone 20, the RFID bracelet 30, and the RFID tag reader 28. As shown in FIG. 3, the biometric scanner 38 is maintained in spaced-apart relation to the bed 10. The biometric scanner 38 is configured to scan biological samples from the patient resting on the bed 10 to confirm the identity of the patient. The biometric scanner 38 may be included within a biometric system 42 as shown in FIG. 3. In some embodiments, the biometric scanner 38 permits the identity of the patient to be confirmed without a recorded verbal acknowledgement of the patient's identity.

The biometric scanner 38 scans biological samples associated with the patient resting on the bed 10 for comparison against reference samples that are stored in the patient's electronic history file. Reference samples may be acquired in an enrollment process coinciding with the patient's first use of the biometric system 42. The reference samples provide affirmative indications of the patient's identity. The reference samples may include samples of the patient's voice, fingerprints, or retina scan images. In another example, the reference samples may include samples of the patient's blood or urine or other biological means for providing DNA evidence that may be used to establish the patient's identity. Similarly, biological samples taken from the patient resting on bed 10 and compared against the reference samples taken during the enrollment process may include the sample types mentioned above.

As shown in FIG. 3, the biometric scanner 38 is configured to communicate with the communication network 34. The reference samples stored in the patient's electronic history file may be retrieved from the medical records database and communicated through the communication network 34 to the biometric scanner 38 as shown in FIG. 3. The biometric scanner 38 is shown in communication with an acknowledgement area 40 in FIG. 3. Reference samples taken during the enrollment process and communicated from the medical records database to the biometric scanner 38 may then be communicated to the acknowledgement area 40 as suggested in FIG. 3.

The acknowledgement area 40 provides a location at which the caregiver may compare the patient's biological samples to the references samples taken during the enrollment process. The acknowledgement area 40 is included in the biometric system 42 as shown in FIG. 3. Biological samples acquired from the patient resting on the bed 10 may be scanned using the biometric scanner 38. The scanned biological samples may be communicated to the acknowledgement area 40 as suggested in FIG. 3. Prior to comparing the biological samples and the reference samples, the biological samples may be matched with the reference samples to determine testing parameters for authenticating the patient's identity. The testing parameters may include a threshold score that is used to generate a comparison template. The comparison template may be used during the comparison of the biological samples and the reference samples to authenticate the patient's identity.

The biometric system 42 may also include a mechanism by which the caregiver acknowledges the comparison template to be used. This mechanism may include a smart card used by the caregiver, a username, or an ID number to select the comparison template prior to comparing the biological samples and the reference samples.

Once the patient's identity is confirmed at the acknowledgement area 40 and communicated to the biometric scanner 38, the patient's identity may be communicated thereafter to the medical records database through the communication network 34. Confirmation of the patient's identity using the biometric system 42 may then be included in the electronic history file maintained for the patient.

The patient's identity may be initially confirmed using biometric system 42 as described above. Patient information contained in the patient's electronic history file may be communicated from the medical records database to the controller 25. The controller 25, in response to receiving the patient information, may issue the scan prompt to the pendant 26 (not shown but may be included in the embodiment shown in FIG. 3) that is viewable by the caregiver or other persons in the vicinity of bed 10.

Once the medication is scanned, the controller 25 may issue the speak prompt to the pendant 26 that is viewable by the caregiver or other persons in the vicinity of the bed 10. In the embodiment shown in FIG. 3, the patient's consent may be indicated via a stylus response or speaking received on the pendant 26 and stored as a patient entry by the controller 25. The controller 25 may add the time and date at which the recording was stored to the patient entry, as well as a patient-identifying indicator.

As suggested in FIG. 3, the scanned medication information and the patient entry of the patient's acknowledgement of his identity may be communicated from the controller 25 to the medical records database via the communication network 34. Thereafter, the patient entry and the scanned medication information may be incorporated into the electronic history file maintained for the patient. Incorporation of the patient entry and the scanned medication data into the patient electronic history file provides evidence of adherence to a protocol for delivering medical care that requires patient identity to be established prior to administering medical care.

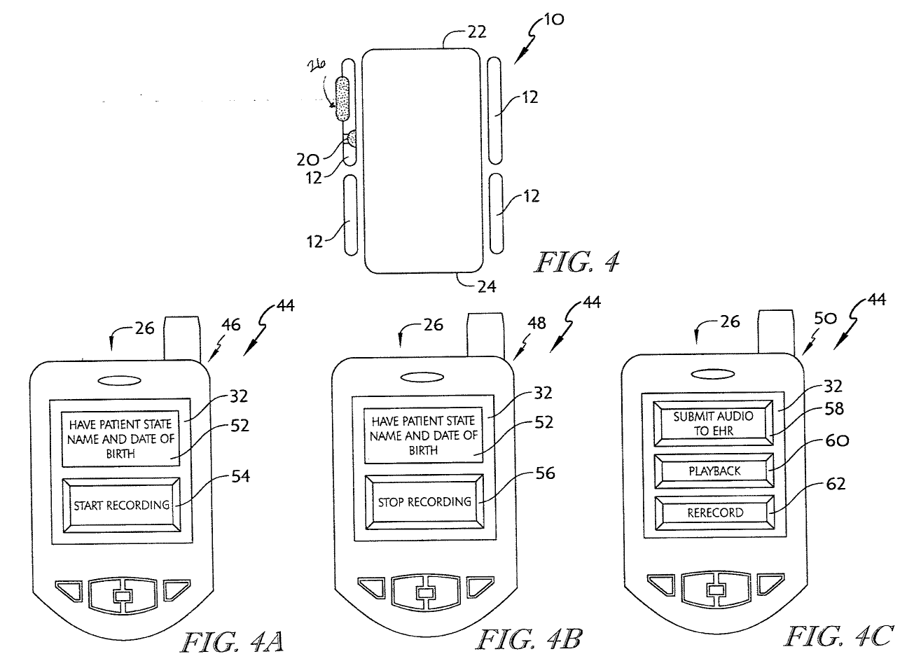

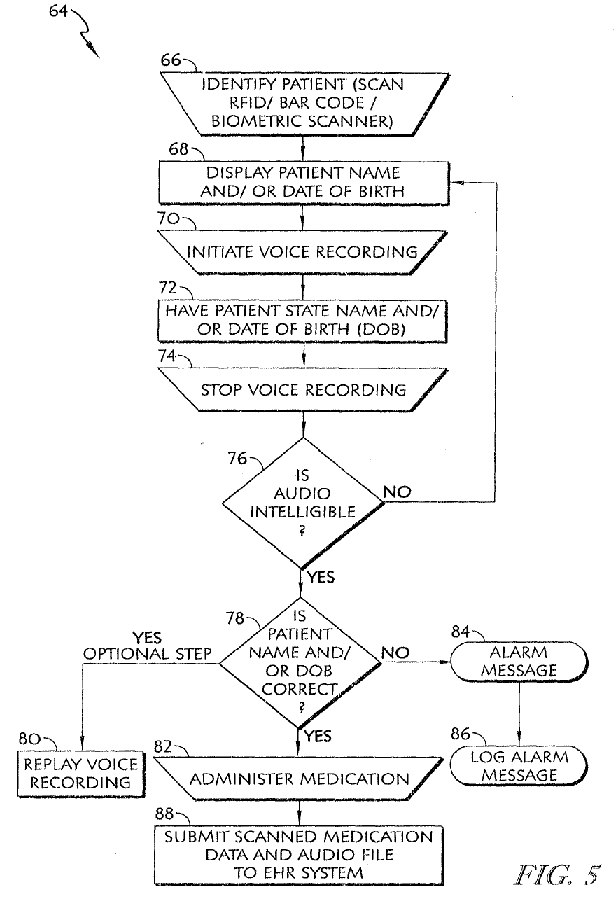

In a fourth embodiment of the present invention shown in FIG. 4, the bed 10 of FIGS. 1 and 2 is shown with the pendant 26 coupled to one of the siderails 12. The microphone 20 is also coupled to one of the siderails 12 as shown in FIG. 4. A series of pendant views 44 are provided in which various visual indications are displayed on the touchscreen display 32 of the pendant 26. The series of pendant views 44 includes a first pendant view 46 shown in FIG. 4A, a second pendant view 48 shown in FIG. 4B, and a third pendant view 50 shown in FIG. 4C.

The first pendant view 46 includes a first visual indication 52 and a second visual indication 54 displayed on the touchscreen display 32 of the pendant 26. The first visual indication 52 states “Have patient state name and date of birth” as shown in FIG. 4A. Second visual indication 54 states “Start recording” as shown in FIG. 4A. First visual indication 52 may issued by the controller 25 to pendant 26 in response to patient information for the patient resting on bed 10 being communicated from the medical records database to the controller 25. In another example, first visual indication 52 may be issued by the controller 25 to the pendant 26 in response to scanning medication to be administered to the patient resting on the bed 10.

The first and second visual indications 52, 54 of the first pendant view 46 direct the caregiver to begin recording the patient's verbal acknowledgement of his identity using the microphone 20. Sound emitted as the patient verbally states his name and date of birth is converted to an electrical signal by the microphone 20. The electrical signal is communicated to the controller 25 to be stored as a patient entry when the recording process is complete.

The second pendant view 48 includes the first visual indication 52 and a third visual indication 56 displayed on the touchscreen display 32 of the pendant 26. The third visual indication 56 states “Stop recording” as shown in FIG. 4B. The third visual indication 56 may coincide with a prompt issued to the pendant 26 by the controller 25 in response to the electrical signal no longer being communicated from the microphone 20 to the controller 25. The third visual indication 56 directs the caregiver to stop the recording of the patient's verbal acknowledgement of his identity using the microphone 20. Once the recording process has been stopped, the caregiver may replay the recording to determine whether it is adequate to confirm the patient's identity as suggested in the third pendant view 50 as shown in FIG. 4B.

The third pendant view 50 includes a fourth visual indication 58, a fifth visual indication 60, and a sixth visual indication 62 displayed on the touchscreen display 32 of the pendant 26 as shown in FIG. 4C. The fourth visual indication 58 states “Submit audio to EHR” as shown in FIG. 4C. The fifth visual indication 60 states “Playback” as shown in FIG. 4C. The sixth visual indication 62 states “Rerecord” as shown in FIG. 4C. The fourth visual indication 58, the fifth visual indication 60, and the sixth visual indication 62 may coincide with prompts issued by the controller 25 to the pendant 26 following the issuance of the third visual indication 56 to the pendant 26. The fourth visual indication 58 directs the controller 25 to store the audio recording as a digital record and communicate the digital record to the medical records database through the communication network 34 for inclusion in the electronic history file maintained for the patient. The fifth visual indication 60 directs the controller 25 to communicate the stored audio recording to the pendant 26 for playback through a speaker (not shown) included in the pendant 26 to determine whether the recording adequately confirms the patient's identity. The sixth visual indication 62 directs the controller 25 to repeat the recording process previously discussed for the first and second pendant views 46, 48 and accompanied by the first, second, and third visual indications 52, 54, and 56.

The frame 9 of the bed 10 illustratively includes a lower frame 11, an upper frame 13, and a deck 15 coupled to the upper frame 13 as shown in FIG. 9. The deck 15 is movable to a plurality of positions as suggested in FIG. 9. The deck 15 includes a head-deck section 17, a seat-deck section 19, a thigh-deck section 21, and a foot-deck section 23. The head-deck section 17 is mounted to the upper frame 13 to pivot about an axis relative to the seat-deck section 19 and to slide relative to the seat-deck section 19 and the upper frame 13 as described in U.S. Publication Nos. 2010/0122415 and 2012/0005832, which are incorporated herein in their entirety. The seat-deck section 19 is coupled to the upper frame 13 to move with the upper frame 13. The thigh-deck section 21 is coupled to the seat-deck section 19 to pivot relative to the seat-deck section 19. The foot-deck section 23 is coupled to the thigh-deck section 21 to pivot relative to the thigh-deck section 21. The foot-deck section 23 is also extendable and retractable to lengthen or shorten the deck 15 as desired by a caregiver or to accommodate repositioning of the deck 15.

As shown in FIG. 5, a first set of controller instructions 64 are shown that define a sequence of steps in which the patient's verbal acknowledgement of his identity is recorded and stored using the bed 10. The first set of controller instructions may be stored in memory 29 included in the controller 25. The first set of controller instructions 64 directs the controller 25 to establish the patient's identity prior to administering medical care in conformance with the hospital's protocol.

The first set of controller instructions 64 includes a patient ID step 66 that directs the patient to be identified. In one example, the patient may be identified using the RFID bracelet 30 and the RFID tag reader 28 as suggested, for example, in FIG. 1. In another example, the patient may be identified using the biometric scanner 38 as suggested in FIG. 3. The patient ID step 66 may coincide with an ID prompt issued by the controller 25 to pendant 26, the ID prompt providing a visual or audible indication to the caregiver to identify the patient.

The first set of controller instructions 64 next proceeds to a display ID step 68 that directs the patient's name and date of birth to be displayed on the pendant 26. Display ID step 68 is executed by the controller 25 after patient ID step 66 in the sequence of steps shown in FIG. 5. Display ID step 68 may involve communication between the controller 25 and the medical records database through the communication network 34 to look-up patient information such as the patient's name and/or date of birth. Additional patient information such as prescription information may be communicated from the medical records database to the controller 25 through the communication network 34 and displayed on the pendant 26 during the display ID step 68.

Next, the first set of controller instructions 64 proceeds to a start voice recording step 70 that directs the caregiver to initiate the voice recording of the patient's acknowledgement of his identity. The start voice recording step 70 is executed after the display ID step 68 in the sequence of steps shown in FIG. 5. The start voice recording step 70 may coincide with a start prompt issued by the controller 25 to the pendant 26. The start prompt provides a visual or audible indication to the caregiver to initiate the voice recording process.

The first set of controller instructions 64 then proceeds to a record step 72 that directs the patient to state his name and/or date of birth for recording using the microphone 20. The record step 72 is executed by the controller 25 after the start voice recording step 70 in the sequence of steps as shown in FIG. 5. The record step 72 may coincide with a speaking prompt issued by the controller 25 to the pendant 26. The speaking prompt provides a visual or audible indication to the caregiver to have the patient state his name and/or date of birth.

The first set of controller instructions 64 further includes a stop voice step 74 that directs the caregiver to stop the voice recording process. The stop voice recording step 74 is executed by the controller 25 after the record step 72 in the sequence of steps as shown in FIG. 5. The stop voice recording step 74 may coincide with a stop prompt issued by the controller 25 to the pendant 26. The stop prompt provides a visual or audible indication to the caregiver to stop the voice recording process.

The first set of controller instructions 64 further includes a check audio step 76 that directs the caregiver to check the audio recorded using the microphone 20 to determine if the recording is intelligible. The check audio step 76 is executed by the controller 25 after the stop voice recording step 74 in the sequence of steps as shown in FIG. 5. The check audio step 76 may coincide with a check prompt issued by the controller 25 to the pendant 26. The check prompt provides a visual or audible indication to the caregiver to determine whether the recorded audio is intelligible or not. If the recorded audio is determined to be intelligible, the controller 25 proceeds forward to the next step in the step sequence as shown in FIG. 5. If the recorded audio is determined not to be intelligible, the controller 25 re-executes the display ID step 68 and proceeds forward thereafter as shown in FIG. 5.

The first set of controller instructions 64 further includes a verify patient information step 78 that directs the caregiver to verify that the patient's name and/or date of birth as stated in the recorded audio are correct. The verify patient information step 78 is executed by the controller 25 after the check audio step 76 in the sequence of steps as shown in FIG. 5. The verify patient information step 78 may coincide with a verify prompt issued by the controller 25 to the pendant 26. The verify prompt provides a visual or audible indication to the caregiver to verify the correctness of the patient's name and/or date of birth as stated in the audio recording. The verify patient information step 78 may require the caregiver to compare the patient information contained in the audio recording to the patient information communicated from the medical records database to the controller 25 through the communication network 34. In another example, the verify patient information step 78 may be performed electronically through the communication network 34 using a first sound recording obtained during the patient's check-in to the hospital and a second sound recording obtained during the record step 72.

The first set of controller instructions 64 further includes an alarm step 84 that directs the controller 25 to issue an alarm message if the caregiver is unable to verify the patient's name and/or date of birth as correct. The alarm step 84 is executed by the controller 25 after the verify patient information step 78 is executed and the patient information is unable to be verified as correct as shown in FIG. 5.

The alarm step 84 includes a log alarm step 86 that directs the controller 25 to store a record of the alarm message issued to the pendant 26 by the controller 25 during the alarm step 84. The log alarm step 86 is executed by the controller 25 after the alarm step 84 is executed as shown in FIG. 5. The record of the alarm message is stored during the log alarm step 86 and may include the time and date that the alarm message appeared as well as a description of the alarm message.

The first set of controller instructions 64 may further include a replay step 80 that directs the caregiver to replay the voice recording initially obtained during the record step 72. The replay step 80 may be executed by the controller 25 after the verify patient information step 78 is executed and the patient information is verified to be correct as shown in FIG. 5. The replay step 80 may coincide with a replay prompt issued by the controlled to the pendant 26. The replay prompt provides a visual or audible indication to the caregiver to replay the voice recording initially obtained during the record step 72.

The first set of controller instructions 64 further includes an administer medication step 82 that directs the caregiver to administer medication to the patient. The administer medication step 82 is executed by the controller 25 after the verify patient information step 78 is executed and the patient information is verified to be correct as shown in FIG. 5. The administer medication step 82 may require the medication to be scanned using the medication scanner 36. The administer medication step 82 may coincide with an administer prompt issued by the controller 25 to the pendant 26. The administer prompt provides a visual or audible indication to the caregiver to administer medication to the patient.

The first set of controller instructions 64 further includes a submit data step 88 as shown in FIG. 5. The submit data step 88 directs the controller 25 to submit the recorded audio file to the medical records database through the communication network 34. The recorded audio file may be included in the patient's electronic history file once it is submitted to the medical records database. In addition, scanned medication data obtained during the administer medication step 82 may be submitted to the medical records database and included in the patient's electronic history file. The recorded audio file and the scanned medication data may be combined with data from the selection input to establish a patient entry in the patient's electronic history file. The submit data step 88 is executed by the controller 25 after the administer medication step 82 in the sequence of steps shown in FIG. 5. The submit data step 88 may coincide with a submit prompt issued by the controller 25 to the pendant 26. The submit prompt provides a visual or audible indication to the caregiver to submit the recorded audio file and scanned medication data to the medical records database.

As shown in FIG. 6, a second set of controller instructions 90 define a sequence of steps in which the patient's verbal acknowledgement of his identity is recorded and stored using the bed 10. The second set of controller instructions 90 direct the controller 25 to establish the patient's identity prior to administering medical care in conformance with the hospital's protocol for delivering medical care.

The second set of controller instructions 90 includes a patient ID step 92 that directs the patient to be identified. The patient may be identified using the RFID bracelet 30 and the RFID tag reader 28. The patient ID step 92 may coincide with an ID prompt issued by the controller 25 to the pendant 26. The ID prompt provides a visual or audible indication to the caregiver to identify the patient and establish an initial identity of the patient.

The second set of controller instructions 90 further includes a retrieve step 94 that directs the controller 25 to retrieve patient information from the medical records database. The retrieve step 94 is executed by the controller 25 after the patient ID step 92 in the sequence of steps shown in FIG. 6. Once the patient is initially identified in the patient ID step 92, the controller 25 may retrieve patient information from the patient's electronic history file located on the medical records database through the communication network 34. As shown in FIG. 6, the patient information may include patient prescription information, special care instructions, or any other relevant information. The patient prescription information may be checked against the medication scanned during the next step discussed below.

The second set of controller instructions 90 includes a medication scan step 96 that directs the caregiver to scan the medication to be administered to the patient. The medication scan step 96 is executed by the controller 25 after the retrieve step 94 in the sequence of steps shown in FIG. 6. The medication scan step 96 may coincide with a scan prompt issued by the controller 25 to the pendant 26. The scan prompt provides a visual or audible indication to the caregiver to scan the medication to be administered to the patient.

The second set of controller instructions 90 further includes a display ID step 98 that directs the controller 25 to display the patient information. The display ID step 98 is executed by the controller 25 after the medication scan step 96 in the sequence of steps shown in FIG. 6. The controller 25 directs patient information to be displayed on the pendant 26 in the display ID step 98. The patient information includes patient name, date of birth, prescription information, and/or scanned medication information as shown in FIG. 6. Patient name and/or date of birth may be ascertained during the patient ID step 92, prescription information may be ascertained during the retrieve step 94, and scanned medication information may be ascertained during the medication scan step 96.

The second set of controller instructions 90 further includes a start voice recording step 100 that directs the caregiver to initiate the voice recording of the patient's acknowledgement of his identity. The start voice recording step 100 is executed by the controller 25 after the display ID step 98 in the sequence of steps shown in FIG. 6. Similar to the start voice recording step 70, the start voice recording step 100 may coincide with a start prompt issued by the controller 25 to the pendant 26. The start prompt provides a visual or audible indication to the caregiver to initiate the voice recording process.

The second set of controller instructions 90 further includes a record step 102 that directs the patient to state his name and/or date of birth for recording using the microphone 20. The record step 102 is executed by the controller 25 after the start voice recording step 100 in the sequence of steps shown in FIG. 6. The record step 102 may coincide with a speak prompt issued by the controller 25 to the pendant 26. The speak prompt provides a visual or audible indication to the caregiver to have the patient state his name and/or date of birth.

The second set of controller instructions 90 further includes a stop voice recording step 104 that directs the caregiver to stop the voice recording process. The stop voice recording step 104 is executed by the controller 25 after the record step 102 in the sequence of steps as shown in FIG. 6. The stop voice recording step 104 may coincide with a stop prompt issued by the controller 25 to the pendant 26. The stop prompt provides a visual or audible indication to the caregiver to stop the voice recording process.

The second set of controller instructions 90 further includes a check audio step 106 that directs the caregiver to check the audio recorded using the microphone 20 to determine if the recording is intelligible as shown in FIG. 6. The check audio step 106 is executed by the controller 25 after the stop voice recording step 104 in the sequence of steps shown in FIG. 6. Similar to the check audio step 76, the check audio step 106 may coincide with a check prompt issued by the controller 25 to the pendant 26. The check prompt provides a visual or audible indication to the caregiver to determine whether the recorded audio is intelligible or not. If the recorded audio is determined to be intelligible, the controller 25 proceeds forward to the next step in the step sequence as shown in FIG. 6. If the recorded audio is determined not to be intelligible, the controller 25 re-executes the display ID step 98 and proceeds forward thereafter as shown in FIG. 6.

The second set of controller instructions 90 further includes a verify patient information step 108 that directs the caregiver to verify that the patient information is correct. The verify patient information step 108 is executed by the controller 25 after the check audio step 106 in the sequence of steps shown in FIG. 6. As shown in FIG. 6, the patient information may include the patient's name, date of birth, prescription information, and scanned medication information. The verify patient information step 108 may coincide with a verify prompt issued by the controller 25 to the pendant 26. The verify prompt provides a visual or audible indication to the caregiver to verify the correctness of the patient information. The verify patient information step 108 may require the caregiver to compare the patient information contained in the audio recording, the patient information communicated from the medical records database to the controller 25 through the communication network 34, and the patient information associated with the medication scan to determine the correctness of the patient information.

The second set of controller instructions 90 further includes an alarm step 114 that directs the controller 25 to issue an alarm message if the caregiver is unable to verify the patient's name, date of birth, or prescription information as correct. The alarm step 114 is executed by the controller 25 after the verify patient information step 108 is executed and the patient information is unable to be verified as correct as shown in FIG. 6. The alarm step 114 includes a log alarm step 116 that directs the controller 25 to store an entry of the alarm message issued to the pendant 26 by the controller 25 during alarm step 114. The log alarm step 116 is executed by the controller 25 after the alarm step 114 is executed as shown in FIG. 6. The entry of the alarm message stored during the log alarm step 116 may include the time and date that the alarm message appeared as well as a description of the alarm message.

The second set of controller instructions 90 may further include a replay step 110 that directs the caregiver to replay the voice recording initially obtained during the record step 102. The replay step 110 may be executed by the controller 25 after the verify patient information step 108 is executed and the patient information is verified to be correct as shown in FIG. 6. The replay step 110 may coincide with a replay prompt issued by the controlled to the pendant 26. The replay prompt provides a visual or audible indication to the caregiver to replay the voice recording initially obtained during record step 102.

The second set of controller instructions 90 further includes an administer medication step 112 that directs the caregiver to administer medication to the patient.

The administer medication step 112 is executed by the controller 25 after the verify patient information step 108 is executed and the patient information is verified to be correct as shown in FIG. 6. The administer medication step 112 may coincide with an administer prompt issued by the controller 25 to the pendant 26. The administer prompt provides a visual or audible indication to the caregiver to administer medication to the patient.

The second set of controller instructions 90 further includes a submit data step 118 that directs the controller 25 to submit the recorded audio file to the medical records database through the communication network 34. The recorded audio file may be included in the patient's electronic history file once it is submitted to the medical records database. In addition, scanned medication data obtained during the medication scan step 96 may be submitted to the medical records database and included in the patient's electronic history file. The submit data step 118 is executed by the controller 25 after the administer medication step 112 in the sequence of steps shown in FIG. 6. The submit data step 118 may coincide with a submit prompt issued by the controller 25 to the pendant 26. The submit prompt provides a visual or audible indication to the caregiver to submit the recorded audio file and scanned medication data to the medical records database.

The second set of controller instructions 90 further includes a chart medication step 120 that directs the controller 25 to chart medication administered to the patient over time. The charted medication information may be communicated from the controller 25 to the medical records database through the communication network 34 for inclusion in the patient's electronic history file. In addition, the controller 25 may be directed to chart protocol administration over time to monitor adherence to the hospital's protocol for delivering medical care. The charted protocol administration information may be communicated from the controller 25 to the medical records database through the communication network 34 for inclusion in the patient's electronic history file. The chart medication step 120 is executed by the controller 25 after the submit data step 118 in the sequence of steps as shown in

FIG. 6. The chart medication step 120 may coincide with a chart prompt issued by the controller 25 to the pendant 26. The chart prompt provides a visual or audible indication to the caregiver to chart medication administered to the patient and protocol administration over time.

As shown in FIG. 7, a third set of controller instructions 122 define a sequence of steps in which the patient's verbal acknowledgement of his identity is recorded and stored using the bed 10. The third set of controller instructions 122 direct the controller 25 to establish the patient's identity prior to administering medical care in conformance with the hospital's protocol for delivering medical care as previously discussed.

The third set of controller instructions 122 includes a patient ID step 124 that directs the patient to be identified. The patient may be identified using the RFID bracelet 30 and the RFID tag reader 28 for example. The patient ID step 124 may coincide with an ID prompt issued by the controller 25 to the pendant 26. The ID prompt provides a visual or audible indication to the caregiver to identify the patient.

The third set of controller instructions 122 further includes a display ID step 126 that directs patient information to be displayed. The display ID step 126 is executed by the controller 25 after the patient ID step 124 in the sequence of steps shown in FIG. 7. The controller 25 directs patient information to be displayed on the pendant 26 in the display ID step 98, including patient name and/or date of birth as shown in FIG. 7.

The third set of controller instructions 122 further includes a retrieve step 128 that directs the controller 25 to retrieve patient information from the medical records database. The retrieve step 128 is executed by the controller 25 after the display ID step 126 in the sequence of steps as shown in FIG. 7. Once the patient's name and/or date of birth is displayed in the display ID step 126, the controller 25 may retrieve patient information from the patient's electronic history file located on the medical records database through the communication network 34. As shown in FIG. 7, the patient information may include prescription information.

The third set of controller instructions 122 further includes a medication scan step 130 that directs the caregiver to scan the medication to be administered to the patient. The medication scan step 130 is executed by the controller 25 after the retrieve step 128 in the sequence of steps as shown in FIG. 7. Similar to the medication scan step 96, the medication scan step 130 may coincide with a scan prompt issued by the controller 25 to the pendant 26. The scan prompt provides a visual or audible indication to the caregiver to scan the medication to be administered to the patient.

The third set of controller instructions 122 further includes a conform step 132 that directs the caregiver to determine whether the medication scanned during the medication scan step 130 conforms to the patient's prescription information retrieved during the retrieve step 128 as shown in FIG. 7. The conform step 132 may also require the caregiver to determine whether the dosage conforms to the patient prescription information retrieved during the retrieve step 128 as shown in FIG. 7. The conform step 132 is executed by the controller 25 after the medication scan step 130 in the sequence of steps as shown in FIG. 7. The conform step 132 may coincide with a conform prompt issued by the controller 25 to the pendant 26. The conform prompt provides a visual or audible indication to the caregiver to determine whether the scanned medication and/or dosage conforms to the patient's prescription information.

The third set of controller instructions 122 further includes a first alarm step 134 that directs the controller 25 to issue an alarm message if the caregiver determines that the scanned medication and/or dosage does not conform to the patient's prescription information. The first alarm step 134 is executed by the controller 25 after the conform step 132 is executed and the caregiver determines that the scanned medication and/or dosage does not conform to the patient's prescription information as shown in FIG. 7.

The first alarm step 134 includes a first log alarm step 136 that directs the controller 25 to store a record of the alarm message issued to the pendant 26 by the controller 25 during first alarm step 134. The first log alarm step 136 is executed by the controller 25 after the first alarm step 134 is executed as shown in FIG. 7. The record of the alarm message stored during the first log alarm step 136 may include the time and date that the alarm message appeared as well as a description of the alarm message.

The third set of controller instructions 122 further includes a start voice recording step 138 that directs the caregiver to initiate the voice recording of the patient's acknowledgement of his identity. The start voice recording step 138 is executed by the controller 25 after the conform step 132 is executed and the medication information and/or dosage is determined to conform to the prescription information as shown in FIG. 7. The start voice recording step 138 may coincide with a start prompt issued by the controller 25 to the pendant 26. The start prompt provides a visual or audible indication to the caregiver to initiate the voice recording process.

The third set of controller instructions 122 further includes a record step 140 that directs the patient to state his name and/or date of birth for recording using microphone 20. The record step 140 is executed by the controller 25 after the start voice recording step 138 in the sequence of steps shown in FIG. 7. The record step 140 may coincide with a speak prompt issued by the controller 25 to the pendant 26. The speak prompt provides a visual or audible indication to the caregiver to have the patient state his name and/or date of birth.

The third set of controller instructions 122 further includes a stop voice recording step 142 that directs the caregiver to stop the voice recording process. The stop voice recording step 142 is executed by the controller 25 after the record step 140 in the sequence of steps as shown in FIG. 7. The stop voice recording step 142 may coincide with a stop prompt issued by the controller 25 to the pendant 26. The stop prompt provides a visual or audible indication to the caregiver to stop the voice recording process.

The third set of controller instructions 122 further includes a check audio step 144 that directs the caregiver to check the audio recorded using the microphone 20 to determine if the recording is intelligible. The check audio step 144 is executed by the controller 25 after the stop voice recording step 142 in the sequence of steps as shown in FIG. 7. The check audio step 144 may coincide with a check prompt issued by the controller 25 to the pendant 26. The check prompt provides a visual or audible indication to the caregiver to determine whether the recorded audio is intelligible or not. If the recorded audio is determined to be intelligible, the controller 25 proceeds forward to the next step in the step sequence as shown in

FIG. 7. If the recorded audio is determined not to be intelligible, the controller 25 re-executes the start voice recording step 138 and proceeds forward thereafter as shown in FIG. 7.

The third set of controller instructions 122 further includes a repeat voice recording step 146 that directs the controller 25 to issue a message to repeat the voice recording process beginning with the start voice recording step 138. Repeat voice recording step 146 is executed by the controller 25 after check audio step 144 is executed and the caregiver determines that the recorded audio is not intelligible as shown in FIG. 7. The message issued by the controller 25 to pendant 26 during repeat voice recording step 146 may be a visual or audible indication to the caregiver.

The third set of controller instructions 122 further includes a verify patient information step 148 that directs the caregiver to verify that the patient information is correct. The verify patient information step 148 is executed by the controller 25 after the check audio step 144 is executed and the recorded audio is determined to be intelligible as shown in FIG. 7. The patient information may include the patient's name and/or date of birth. The verify patient information step 148 may coincide with a verify prompt issued by the controller 25 to the pendant 26. The verify prompt provides a visual or audible indication to the caregiver to verify the correctness of the patient information contained in the audio recording.

The third set of controller instructions 122 further includes a second alarm step 154 that directs the controller 25 to issue an alarm message if the caregiver is unable to verify the patient's name and/or date of birth as correct. The second alarm step 154 is executed by the controller 25 after the verify patient information step 148 is executed and the patient information is unable to be verified as correct as shown in FIG. 7. The second alarm step 154 includes a second log alarm step 156 that directs the controller 25 to store a record of the alarm message issued to the pendant 26 by the controller 25 during the second alarm step 154. The second log alarm step 156 is executed by the controller 25 after the second alarm step 154 is executed as shown in FIG. 7. The record of the alarm message stored during the second log alarm step 156 may include the time and date that the alarm message appeared as well as a description of the alarm message.

The third set of controller instructions 122 may further include a replay step 150 that directs the caregiver to replay the voice recording initially obtained during the record step 140. The replay step 150 may be executed by the controller 25 after the verify patient information step 148 is executed and the patient information is verified to be correct as shown in FIG. 7. The replay step 150 may coincide with a replay prompt issued by the controlled to the pendant 26. The replay prompt provides a visual or audible indication to the caregiver to replay the voice recording initially obtained during record step 140.

The third set of controller instructions 122 further includes an administer medication step 152 that directs the caregiver to administer medication to the patient. The administer medication step 152 is executed by the controller 25 after the verify patient information step 148 is executed and the patient information is verified to be correct as shown in FIG. 7. The administer medication step 152 may coincide with an administer prompt issued by the controller 25 to the pendant 26. The administer prompt provides a visual or audible indication to the caregiver to administer medication to the patient.

The third set of controller instructions 122 further includes a submit data step 158 that directs the controller 25 to submit the recorded audio file to the medical records database through the communication network 34. The recorded audio file may be included in the patient's electronic history file once it is submitted to the medical records database. In addition, scanned medication data obtained during the administer medication step 152 may be submitted to the medical records database and included in the patient's electronic history file. The submit data step 158 is executed by the controller 25 after the administer medication step 152 in the sequence of steps shown in

FIG. 7. The submit data step 158 may coincide with a submit prompt issued by the controller 25 to the pendant 26. The submit prompt provides a visual or audible indication to the caregiver to submit the recorded audio file and scanned medication data to the medical records database.

The third set of controller instructions 122 further includes a chart medication step 160 that directs the controller 25 to chart medication administered to the patient over time. The charted medication information may be communicated from the controller 25 to the medical records database through the communication network 34 for inclusion in the patient's electronic history file. In addition, the controller 25 may be directed to chart protocol administration over time to monitor adherence to the hospital's protocol for delivering medical care. The charted protocol administration information may be communicated from the controller 25 to the medical records database through the communication network 34 for inclusion in the patient's electronic history file. The chart medication step 160 is executed by the controller 25 after the submit data step 158 in the sequence of steps shown in FIG. 7. The chart medication step 160 may coincide with a chart prompt issued by the controller 25 to the pendant 26. The chart prompt provides a visual or audible indication to the caregiver to chart medication administered to the patient and protocol administration over time.

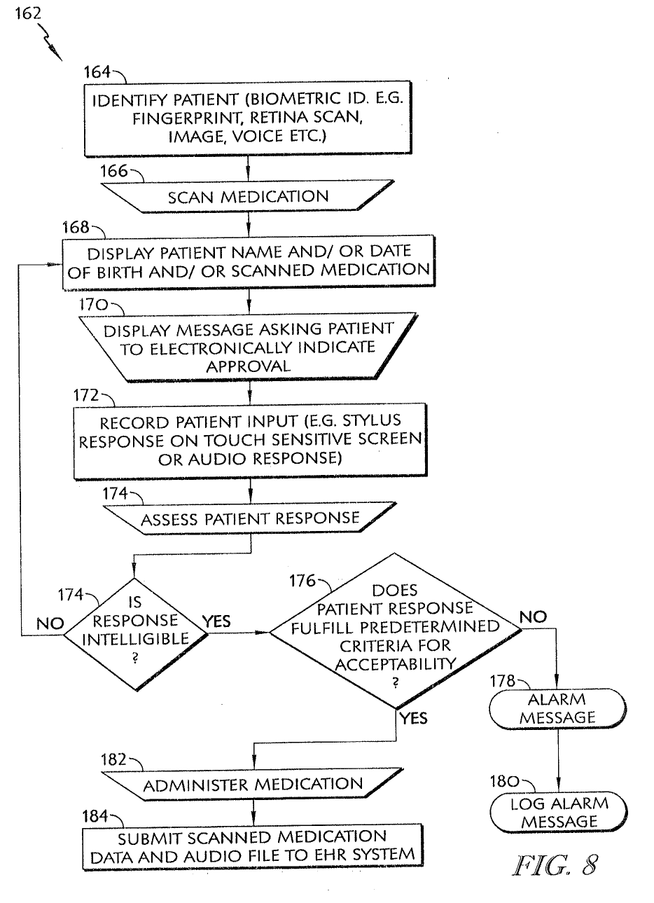

As shown in FIG. 8, a fourth set of controller instructions 162 are shown that define a sequence of steps in which the patient's identity is determined using biometric data and stored using the bed 10. The fourth set of controller instructions 162 direct the controller 25 to establish the patient's identity prior to administering medical care in conformance with the hospital's protocol for delivering medical care as previously discussed.

The fourth set of controller instructions 162 include a patient ID step 164 that directs the patient to be identified. The patient may be identified using the biometric scanner 38 as discussed with respect to the embodiment shown in FIG. 3. The patient ID step 164 may coincide with an ID prompt issued by the controller 25 to pendant 26. The ID prompt provides a visual or audible indication to the caregiver to identify the patient using the biometric scanner 38.

The fourth set of controller instructions 162 further includes a medication scan step 166 that directs the caregiver to scan the medication to be administered to the patient. The medication scan step 166 is executed by the controller 25 after the patient ID step 164 in the sequence of steps as shown in FIG. 8. The medication scan step 166 may coincide with a scan prompt issued by the controller 25 to the pendant 26. The scan prompt provides a visual or audible indication to the caregiver to scan the medication to be administered to the patient.

The fourth set of controller instructions 162 further includes a display ID step 168 that directs patient information to be displayed. The display ID step 168 is executed by the controller 25 after the medication scan step 166 in the sequence of steps as shown in FIG. 8. The controller 25 directs patient information to be displayed on the pendant 26 in the display ID step 168. The patient information includes the patient name and/or date of birth and/or scanned medication information.

The fourth set of controller instructions 162 further includes a request approval step 170 that requests that the patient indicate electronically his approval to receive medical treatment. The request approval step 170 is executed by the controller 25 after the display ID step 168 in the sequence of steps as shown in FIG. 8. The controller 25 issues a message to the pendant 26 during the request approval step 170. The message provides a visual or audible indication to the caregiver or patient requesting that the patient indicate electronically his approval to receive medical treatment as shown in FIG. 8.

The fourth set of controller instructions 162 further includes a record patient input step 172 that directs the caregiver to record the patient's response to the request to indicate approval to receive medical treatment. The record patient input step 172 is executed by the controller 25 after the request approval step 170 in the sequence of steps as shown in FIG. 8. The patient's response may be a stylus response on the touchscreen display 32 of the pendant 26. In another example, the patient's response may be a verbal acknowledgement of his approval that is recorded electronically using the biometric scanner 38. The record patient input step 172 may coincide with a record prompt issued by the controller 25 to the pendant 26. The record prompt provides a visual or audible indication to the caregiver to record the patient's response electronically.

The fourth set of controller instructions 162 further includes a check response step 174 that directs the caregiver to assess the patient's response. The check response step 174 is executed by the controller 25 after the record patient input step 172 in the sequence of steps as shown in FIG. 8. The check response step 174 requires the caregiver to determine whether the patient response is intelligible. The check response step 174 may coincide with an assess prompt issued by the controller 25 to the pendant 26. The assess prompt provides a visual or audible indication to the caregiver to assess the patient's response and determine whether the response is intelligible. If the patient response is determined to be intelligible, then the controller 25 proceeds forward to the next step as shown in FIG. 8. If the patient's response is determined not to be intelligible, then the controller 25 re-executes the display ID step 168 and proceeds forward thereafter as shown in FIG. 8.

The fourth set of controller instructions 162 further includes a determine acceptability step 176 that directs the caregiver to determine whether the patient response fulfills predetermined criteria for acceptability as shown in FIG. 8. The determine acceptability step 176 is executed by the controller 25 after the check response step 174 as shown in FIG. 8. Predetermined criteria for acceptability might include confirmation by the caregiver that the patient has been identified using the biometric scanner 38 and that the patient has intelligibly indicated his approval to receive the scanned medication using the touchscreen display 32 or the biometric scanner 38. The determine acceptability step 176 may coincide with a determine prompt issued by the controller 25 to the pendant 26. The determine prompt provides a visual indication or audible indication to the caregiver to determine whether the patient's response fulfills the predetermined criteria for acceptability.

The fourth set of controller instructions 162 further includes an alarm step 178 that directs the controller 25 to issue an alarm message if the caregiver determines that the patient response does not fulfill the predetermined acceptability criteria. The alarm step 178 occurs after the determine acceptability step 176 and the patient response is determined not to fulfill the predetermined acceptability criteria. The alarm step 178 includes a log alarm step 180 that directs the controller 25 to store a record of the alarm message issued to the pendant 26 by the controller 25 during the alarm step 178. The log alarm step 180 is executed by the controller 25 after the alarm step 178 is executed as shown in FIG. 8. The record of the alarm message stored during the log alarm step 180 may include the time and date that the alarm message appeared as well as a description of the alarm message.

The fourth set of controller instructions 162 further includes an administer medication step 182 that directs the caregiver to administer medication to the patient. The administer medication step 182 is executed by the controller 25 after the determine acceptability step 176 is executed and the patient response is determined to fulfill the predetermined criteria for acceptability. The administer medication step 182 may coincide with an administer prompt issued by the controller 25 to the pendant 26. The administer prompt provides a visual or audible indication to the caregiver to administer medication to the patient.

The fourth set of controller instructions 162 further includes a submit data step 184 that directs the controller 25 to submit the recorded patient response to the medical records database through the communication network 34. The recorded patient response may be included in the patient's electronic history file once it is submitted to the medical records database. In addition, scanned medication data obtained during the administer medication step 182 may be submitted to the medical records database and included in the patient's electronic history file. The submit data step 184 is executed by the controller 25 after administer medication step 182 in the sequence of steps shown in FIG. 8. The submit data step 184 may coincide with a submit prompt issued by the controller 25 to the pendant 26. The submit prompt provides a visual or audible indication to the caregiver to submit the recorded patient response and scanned medication data to the medical records database.

Although certain illustrative embodiments have been described in detail above, variations and modifications exist within the scope and spirit of this disclosure as described and as defined in the following claims.

1. A patient support apparatus comprising
a support frame,
an input sensor configured to provide a first input signal indicative of a verbal acknowledgement of a patient's identity provided by a patient, and
a controller coupled to the support frame and including a processor and memory, the controller configured to receive the first input signal, associate the first input signal with a patient identity to establish a first patient entry in a patient's medical record, and store the first patient entry in the patient's medical record in memory so that evidence of adherence to a protocol is established.

2. The patient support apparatus of claim 1, wherein the input sensor is a microphone.

3. The patient support apparatus of claim 2, further comprising a siderail coupled to the support frame to move relative to the support frame and the microphone is coupled to the siderail to move therewith.

4. The patient support apparatus of claim 2, further comprising a pendant coupled to the support frame to move relative to the support frame and the microphone is coupled to the pendant to move therewith.

5. The patient support apparatus of claim 1, wherein the controller is further configured to add to the first patient entry a date in which the first input signal was received and a time in which the first input signal was received.

6. The patient support apparatus of claim 1, further comprising a communication link coupled to the controller to communicate the first patient entry to an external information system.

7. The patient support apparatus of claim 1, further comprising a selection input coupled to the controller and configured to provide a selection input signal indicative of a medical therapy to be provided to a patient resting on the support frame and the controller is configured to determine if the medical therapy is appropriate for the patient and issue a speaking prompt to the patient to cause the patient to speak so that the input sensor provides the first input.

8. The patient support apparatus of claim 7, wherein the controller is further configured to issue an administer prompt if the medical therapy is appropriate for the patient that causes the caregiver to administer the medical therapy to the patient.

9. The patient support apparatus of claim 8, wherein the controller is further configured to associate the selection input signal, the patient identity, and the first input signal to establish a second patient entry in the patient's medical record and store the second patient entry in the memory.

10. The patient support apparatus of claim 9, further comprising a communication link coupled to the controller to communicate the second patient entry to an external information system.

11. The patient support apparatus of claim 7, wherein the speaking prompt is a visual prompt.

12. The patient support apparatus of claim 7, wherein the speaking prompt is an audible prompt.

13. The patient support apparatus of claim 7, wherein the speaking prompt includes an audible prompt and a visual prompt.

14. The patient support apparatus of claim 7, further comprising a medication scanner coupled to the controller and configured to provide a medication input signal indicative of a medication scanned by the medication scanner to the controller, the controller being further configured to issue a scan prompt to a caregiver to cause the caregiver to scan the medication, receive the medication input signal, and determine if the medication scanned is appropriate for the patient.

15. The patient support apparatus of claim 14, wherein the controller is further configured to issue an administer prompt if the medication is appropriate for the patient that causes the caregiver to administer the medication to the patient.

16. The patient support apparatus of claim 15, wherein the controller is further configured to associate the medication input signal with the patient identity and the first input signal to establish a second patient entry of the patient's medical record and store second patient entry in the memory.

17. The patient support apparatus of claim 16, further comprising a communication link coupled to the controller to communicate the first and second patient entries to a hospital information system.

18. The patient support apparatus of claim 7, further comprising a medication scanner coupled to the controller and configured to provide a medication input signal indicative of a medication scanned by the medication scanner to the controller, the controller being further configured to associate the medication input signal, the selection input signal, the patient identity, and the first input signal to establish a second patient entry in the patient's medical record and store the second patient entry in the memory.

19. A method of obtaining a patient entry of a patient's medical record, the method comprising the steps of
receiving an initial identity signal from a first sensor coupled to a patient support apparatus, the initial identity signal indicative of a patient's initial identity,
recording a verbal acknowledgement of the patient's identity provided by the patient using a microphone coupled to the patient support apparatus to provide a recording that confirms the patient's initial identity,
storing the recording in memory included in the patient support apparatus to establish a patient entry of a patient's medical record, and
transmitting the patient entry to a hospital information system.

20. The method of claim 19, further comprising the step of charting an accumulation of patient entries of the patient over time to provide evidence of adherence to a protocol for delivering medical care.
